(19) United States
(12) Patent Application Publication
(10) Pub. No.: US 2024/0338189 A1
(43) Pub. Date: Oct. 10, 2024

(54) PROVIDING EXPERIENTAL INFORMATION TO EQUIVALENT SOFTWARE INSTALLATIONS

(71) Applicant: INTERNATIONAL BUSINESS MACHINES CORPORATION, ARMONK, NY (US)

(72) Inventors: Amber Morgan, Dallas, TX (US); Logan Bailey, Atlanta, GA (US); Jeremy R. Fox, Georgetown, TX (US); Zachary A. Silverstein, Georgetown, TX (US)

(21) Appl. No.: 18/295,683

(22) Filed: Apr. 4, 2023

(51) Int. Cl. G06F 8/61; G06F 8/36

(52) U.S. Cl. CPC G06F 8/61; G06F 8/36

(57) ABSTRACT

A computer-implemented method, a computer system and a computer program product assist a software installation through information about equivalent experiences. The method includes detecting an installation of a software application on a computing device. The method also includes obtaining successful installation data, where the successful installation data includes information about a prior installation of the software application on a known computing device. In addition, the method includes identifying an equivalent installation in the successful installation data, wherein the equivalent installation comprises the prior installation of the software application having a common characteristic to the current installation of the software application. Lastly, the method includes reproducing the equivalent installation on the computing device.

### BACKGROUND

Embodiments relate generally to the field of software installation, and more specifically, to providing information about successful experiences to equivalent software installations.

In today's computing environment, it may be common for multiple users to download and install new software on computing devices, such as patches that may be distributed by a developer for solving an emergency issue in a public deployment or a group of users in an organization that requires deployment of the same software on a set of computing devices that may be identical. Whether the installation is manual or automatic, users or other processes may attempt a software installation without any experiential information about equivalent installations, and therefore encounter inefficiencies or other problems in deploying software that may not be experienced by a similar user or process.

### SUMMARY

An embodiment is directed to a computer-implemented method for assisting software installations through information about equivalent experiences. The method may include detecting a current installation of a software application on a computing device. The method may also include obtaining successful installation data, where the successful installation data includes information about a prior installation of the software application on a known computing device. In addition, the method may include identifying an equivalent installation in the successful installation data, where the equivalent installation comprises the prior installation of the software application having a common characteristic to the current installation of the software application. Lastly, the method may include reproducing the equivalent installation on the computing device.

In another embodiment, the method may include capturing selected options for the current installation of the software application at the computing device and recording command line inputs associated with the selected options for the current installation of the software application at the computing device. In this embodiment, the method may also include recording screen images of the computing device associated with the current installation of the application and generating a replayable input sequence based on the selected options, the command line inputs and the screen images.

In a further embodiment, the method may include determining that the current installation of the software application is completed successfully on the computing device and transmitting a notification of an availability of the successful installation data, where the successful installation data includes the selected options, the command line inputs, the screen images and the replayable input sequence.

In an additional embodiment, the method may include registering the computing device with a group of known devices, where the group of known devices includes the known computing device. In this embodiment, the method may also include associating the group of known devices with a successful installation database and storing the successful installation data in the successful installation database.

In yet another embodiment, the reproducing the equivalent installation on the computing device may comprise performing actions of the replayable input sequence automatically on the computing device.

In still another embodiment, the reproducing the equivalent installation on the computing device may comprise a user of the computing device manually performing one or more actions on the computing device, wherein the actions are selected from a group consisting of: entering the selected options on the computing device, entering the command line inputs on the computing device, and reproducing the screen images.

In another embodiment, the identifying the equivalent installation may use a machine learning model that predicts an equivalence of software installations based on information about historical software installations.

In addition to a computer-implemented method, additional embodiments are directed to a computer system and a computer program product for assisting software installations through information about equivalent experiences.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that assists software installations through information about parallel experiences according to an embodiment.

### DETAILED DESCRIPTION

In the current information technology (IT) environment, it may be common for an organization or a large group of users to download and install new software on individual computing devices. For instance, a software developer may roll out a new version that many users download and install on a host of computing devices. In addition, an organization may approve a new version or patch of software that multiple users need to download and install. Even if these sorts of installations are automatic or carried out by a central server, the actual installations usually occur on separate computing devices that generally do not have any understanding of the experiences of other installations. This means that results may differ across installations, such that many times one software installation may be successful while an installation of the same software on the same or similar hardware, which should be an equivalent installation, may fail. A successful installation may be one in which the software has completed a successful installation and runs properly on the device where it was installed. One of ordinary skill in the art will recognize that there are many reasons for a software installation to fail. This may include improper downloads from issues such as a network timeout or may include problems with the actual installation process, e.g., an incorrect choice of an option by a user. Likewise, one of ordinary skill in the art may recognize that the indication of failure for a software installation may take many forms, e.g., a timeout when attempting to communicate with the software or detection of a crash of the computing device. Because installation of complex software systems typically involves many options allowing for numerous combinations of possible scenarios, a user performing the installation may need guidance in making choices and understanding the potential implications of those choices and as a result, an installation may include warning messages and other guidance to the users during the installation of the software.

It may therefore be useful to provide a method or system to assist software installations through information about equivalent experiences. Such a method or system may capture experiential information about a successful software installation, including specific steps taken by the user to install a software application using technologies such as screen recording or the capture of command line inputs or replayable input sequences along with specifics about a computing device and application involved in the installation, and share that information with known devices, or those computing devices that may have registered in a group or are otherwise known to the computing device that may be capturing a successful software installation. In addition to providing guidance, the method or system may automatically act upon the experiential information to case the software installation on the known device. Such a method or system may relieve the frustration of users that may download and install software applications and may also increase the efficiency of the installation process, which may increase the use of the application.

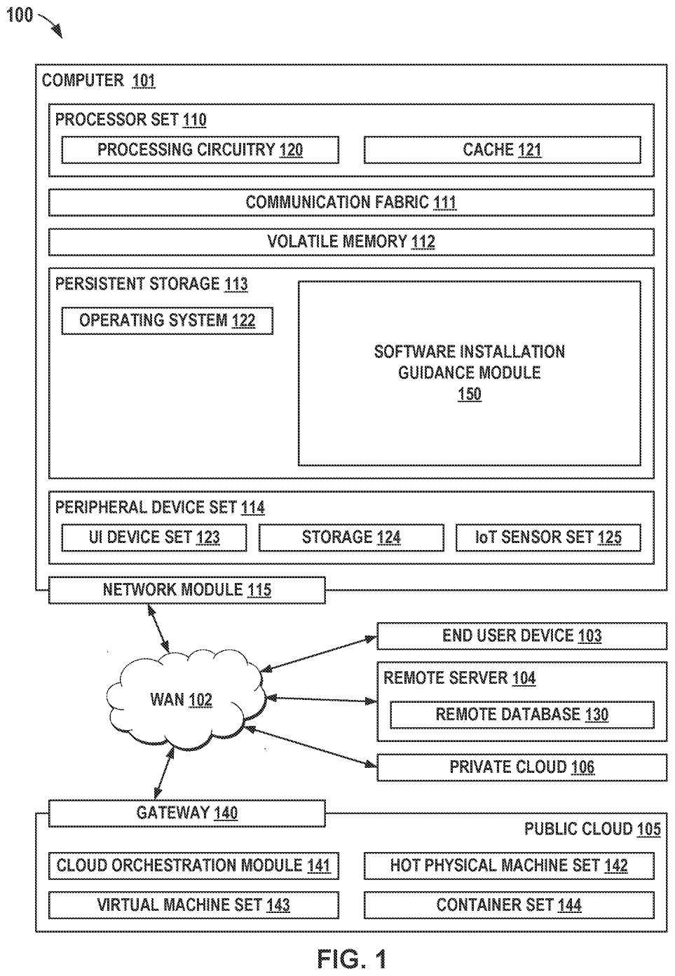

Referring to FIG. 1, computing environment 100 contains an example of an environment for the execution of at least some of the computer code involved in performing the inventive methods, such as software installation guidance module 150. In addition to software installation guidance module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and software installation guidance module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in software installation guidance module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in software installation guidance module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to assist software installations using information about equivalent experiences. In particular, software installation guidance module 150 may detect the initiation of a software installation on a computing device. Detection may also include learning specific information about a software application being installed, such as the version or other details about the application, as well as specifics about the computing device, which may include but is not limited to an operating system in use or other details such as processor type or storage being used.

The software installation guidance module 150 may then obtain successful installation data from a known device. For these purposes, the computing device may be registered with a group of known devices, such that a database may be used by the module 150 to obtain installation data. It should be noted that a formal relationship need not be established between two specific devices, it is only required that successful installation data be available to the computing device on which the software installation has been initiated. In an example, an organization that may have knowledge of the computing devices under its control may keep a database with information about the software installations that may have occurred. In this example, any of the devices under the organization's control may access the database to obtain successful installation data. Also, because the software installation that was initiated may be successful, recording of the installation using appropriate technology may also be initiated at this step to, for instance, enable adding the results to the database described above. For the purposes of this process, failed software installations may not be stored and any installation data that may be provided by the process or requested by the module 150 may include instances where the software installation was successful.

At this point, the software installation guidance module 150 may identify an equivalent installation in the successful installation data. An equivalent installation may be a situation that is the same or similar to the software installation that may have been initiated. Equivalence may include any aspect of the current software installation that may be the same or similar to the successful installation data, for instance hardware specifications of the computing device being used in the software installation as compared to the known device that produced the successful installation data. An identified equivalent installation may then be reproduced by the current computing device, either manually through guidance that may be sent to the user attempting the current software installation or automatically by performing specific commands or actions that may be contained within the successful installation data if such data includes a replayable input sequence.

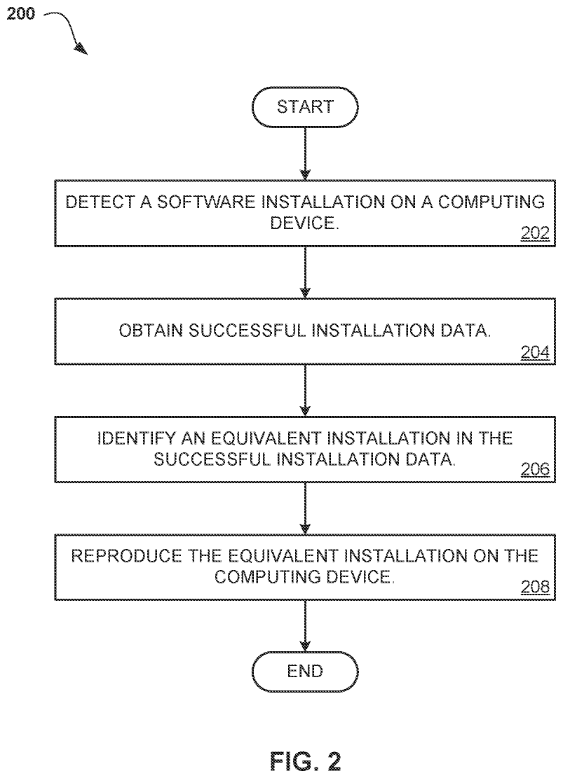

Referring to FIG. 2, an operational flowchart illustrating a process 200 that assists software installations using information about equivalent experiences is depicted according to at least one embodiment. At 202, the initiation of a software installation may be detected on a computing device. A software installation may be initiated with a mouse click or other manual input by a user on the computing device or may be automatically initiated by the download of a software application, which may itself be a manual or automatic action taken by the user of the computing device or a notification or other action that may be taken remotely with respect to the computing device.

In an embodiment, the computing device may also be registered with a group of known devices for the purposes of software installations. As an example, one user may download a software application for installation and may know another user nearby who may want to install the same software application. These users may both register with a group of known devices, separately or in unison, or may simply link to each other as known devices. Such registration may be done at any time before, after or at the same time as the detection of a software installation and the group may be formed for any reason, such as the example above or, for instance, all the computing devices of an organization may be in a group of known devices. A computing device may also actively seek a group of known devices for registration based on a characteristic of the computing device, such as user with a common operating system or other computer hardware. The group of known devices may also include a successful installation database, where any information about successful installations of software applications, or successful installation data as described below, may be stored for use by the group of known devices. One of ordinary skill in the art will recognize that the database is not required, and each computing device may also store its own successful installation data. It should also be noted that, in this embodiment, it may be necessary for the computing device to be authenticated when registering with a group of known devices.

At 204, successful installation data may be obtained from a known device or, alternatively, the successful installation database described above. A known device may be a member of the group of known devices or may be a single computing device that may be known to the computing device.

At this step, successful installation data may be created by any computing device through one or more techniques, including but not limited to capturing selected options for the current installation of the software application, recording command line inputs associated with the selected options for the current installation, or recording screen images of the computing device associated with the current installation. Additionally, a task mining agent or other technique may be used to capture inputs from the user interface to recreate an installation simulation or guidance and a replayable input sequence may be generated, where the input sequence may be replayed by another computing device to reproduce the installation exactly as it may be performed on the computing device. In addition to the information specific to the installation, successful installation data may include specific information about the computing device, such as hardware specifications, and may also include specific information about the device's connection to the group of known devices, such that similarities of the device to others in the group may be learned. Once a software installation is successful at the computing device, the data described above, known as successful installation data, may be stored locally at the computing device or transmitted to the successful installation database and notification may be sent to the group of known devices of the availability of successful installation data related to the computing device.

It should be noted that all collection of data specific to any user or any video, audio or text that may personally identify that user or is sensitive in any other way, such as information that may be included in a screen image or within any data captured that may be relevant to the software installation, requires the informed consent of all people whose information may be collected and analyzed. Consent may be obtained in real time or through a prior waiver or other process that informs a subject that their information may be captured by a device or other process and that the information may be used to reproduce a software installation on another computing device. The information owner is free to decide at any time to revoke consent for use of sensitive information as these settings are permanently retained to keep complete control over their informed consent to use sensitive information in the process described herein. The consent described here may also refer to allowing some, or any, data relating to the information owner from being sent to a local server, cloud server or any other location. The owner has complete control on the transmission of information that may be sensitive or personally identify the owner of the information.

At 206, an equivalent installation may be identified in the successful installation data. Equivalent installations may be software installations that have the same or similar characteristics, such as the same computer hardware. This step may be accomplished by comparing the current software installation to the prior software installation that may be embodied in the successful installation that may be obtained.

In an embodiment, a supervised machine learning model may be trained to predict the equivalence of multiple software installations based on information about historical software installations. One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, training data for the model may include any prior software installation for which data may be available, including but not limited to the successful installation data that may be available to the computing device, either from a known device or a successful installation database. The training data may be collected from a single software installation or from multiple software installations over a longer period of time. The results may be stored in a database so that the data is most current, and the output would always be up to date.

At 208, the equivalent installation may be reproduced on the computing device. Reproduction for the purposes of this step may include either an automated installation, such as the automatic replaying of an input sequence extracted from the successful installation data, or a manual installation, where a user may be presented with information such as a screen image or video that shows specific options to choose or mouse clicks or other manual inputs to perform and then the user follows what may be shown on the computing device. It should be noted that users or the computing device may indicate back to the group of known devices or the successful installation database about the success or failure of the software installation on the computing device. This feedback may be used to refine the successful installation data, such that the indication of a failure may change whether the successful installation data may be made available to specific computing devices or the notifications that may be transmitted regarding the availability of successful installation data. In an embodiment, such feedback may also be used to retrain the machine learning models described above, including the prediction of equivalence, and further instances of machine learning models may also be used to maintain the successful installation database or other storage such that it may be noted with further specificity whether or not certain successful installation data may be used for specific computing devices.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for assisting a software installation through information about equivalent experiences, the computer-implemented method comprising:
detecting a current installation of a software application on a computing device;
obtaining successful installation data, wherein the successful installation data includes information about a prior installation of the software application on a known computing device;
identifying an equivalent installation in the successful installation data, wherein the equivalent installation comprises the prior installation of the software application having a common characteristic to the current installation of the software application; and
reproducing the equivalent installation on the computing device.

2. The computer-implemented method of claim 1, further comprising:
capturing selected options for the current installation of the software application at the computing device;
recording command line inputs associated with the selected options for the current installation of the software application at the computing device;
recording screen images of the computing device associated with the current installation of the software application; and
generating a replayable input sequence based on the selected options, the command line inputs and the screen images.

3. The computer-implemented method of claim 2, further comprising:
determining that the current installation of the software application is completed successfully on the computing device; and
transmitting a notification of an availability of the successful installation data, wherein the successful installation data includes the selected options, the command line inputs, the screen images and the replayable input sequence.

4. The computer-implemented method of claim 3, further comprising:
registering the computing device with a group of known devices, wherein the group of known devices includes the known computing device;
associating the group of known devices with a successful installation database; and
storing the successful installation data in the successful installation database.

5. The computer-implemented method of claim 2, wherein the reproducing the equivalent installation on the computing device comprises performing actions of the replayable input sequence automatically on the computing device.

6. The computer-implemented method of claim 2, wherein the reproducing the equivalent installation on the computing device comprises a user of the computing device manually performing one or more actions on the computing device, wherein the actions are selected from a group consisting of: entering the selected options on the computing device, entering the command line inputs on the computing device, and reproducing the screen images.

7. The computer-implemented method of claim 1, wherein the identifying the equivalent installation uses a machine learning model that predicts an equivalence of software installations based on information about historical software installations.

8. A computer system for assisting software installations through information about equivalent experiences, the computer system comprising:
one or more processors, one or more computer-readable memories, and one or more computer-readable storage media;
program instructions, stored on at least one of the one or more computer-readable storage media for execution by at least one of the one or more processors via at least one of the one or more memories, to detect a current installation of a software application on a computing device;
program instructions, stored on at least one of the one or more computer-readable storage media for execution by at least one of the one or more processors via at least one of the one or more memories, to obtain successful installation data, wherein the successful installation data includes information about a prior installation of the software application on a known computing device;
program instructions, stored on at least one of the one or more computer-readable storage media for execution by at least one of the one or more processors via at least one of the one or more memories, to identify an equivalent installation in the successful installation data, wherein the equivalent installation comprises the prior installation of the software application having a common characteristic to the current installation of the software application; and
program instructions, stored on at least one of the one or more computer-readable storage media for execution by at least one of the one or more processors via at least one of the one or more memories, to reproduce the equivalent installation on the computing device.

9. The computer system of claim 8, further comprising:
program instructions, stored on at least one of the one or more computer-readable storage media for execution by at least one of the one or more processors via at least one of the one or more memories, to capture selected options for the current installation of the software application at the computing device;
program instructions, stored on at least one of the one or more computer-readable storage media for execution by at least one of the one or more processors via at least one of the one or more memories, to record command line inputs associated with the selected options for the current installation of the software application at the computing device;
program instructions, stored on at least one of the one or more computer-readable storage media for execution by at least one of the one or more processors via at least one of the one or more memories, to record screen images of the computing device associated with the current installation of the software application; and
program instructions, stored on at least one of the one or more computer-readable storage media for execution by at least one of the one or more processors via at least one of the one or more memories, to generate a replayable input sequence based on the selected options, the command line inputs and the screen images.

10. The computer system of claim 9, further comprising:
program instructions, stored on at least one of the one or more computer-readable storage media for execution by at least one of the one or more processors via at least one of the one or more memories, to determine that the current installation of the software application is completed successfully on the computing device; and
program instructions, stored on at least one of the one or more computer-readable storage media for execution by at least one of the one or more processors via at least one of the one or more memories, to transmit a notification of an availability of the successful installation data, wherein the successful installation data includes the selected options, the command line inputs, the screen images and the replayable input sequence.

11. The computer system of claim 10, further comprising:
program instructions, stored on at least one of the one or more computer-readable storage media for execution by at least one of the one or more processors via at least one of the one or more memories, to register the computing device with a group of known devices, wherein the group of known devices includes the known computing device;
program instructions, stored on at least one of the one or more computer-readable storage media for execution by at least one of the one or more processors via at least one of the one or more memories, to associate the group of known devices with a successful installation database; and
program instructions, stored on at least one of the one or more computer-readable storage media for execution by at least one of the one or more processors via at least one of the one or more memories, to store the successful installation data in the successful installation database.

12. The computer system of claim 9, wherein the reproducing the equivalent installation on the computing device comprises performing actions of the replayable input sequence automatically on the computing device.

13. The computer system of claim 9, wherein the reproducing the equivalent installation on the computing device comprises a user of the computing device manually performing one or more actions on the computing device, wherein the actions are selected from a group consisting of: entering the selected options on the computing device, entering the command line inputs on the computing device, and reproducing the screen images.

14. The computer system of claim 8, wherein the identifying the equivalent installation uses a machine learning model that predicts an equivalence of software installations based on information about historical software installations.

15. A computer program product for assisting software installations through information about equivalent experiences, the computer program product comprising:
one or more computer-readable storage media;
program instructions, stored on at least one of the one or more computer-readable storage media, to detect a current installation of a software application on a computing device;
program instructions, stored on at least one of the one or more computer-readable storage media, to obtain successful installation data, wherein the successful installation data includes information about a prior installation of the software application on a known computing device;
program instructions, stored on at least one of the one or more computer-readable storage media, to identify an equivalent installation in the successful installation data, wherein the equivalent installation comprises the prior installation of the software application having a common characteristic to the current installation of the software application; and
program instructions, stored on at least one of the one or more computer-readable storage media, to reproduce the equivalent installation on the computing device.

16. The computer program product of claim 15, further comprising:
program instructions, stored on at least one of the one or more computer-readable storage media, to capture selected options for the current installation of the software application at the computing device;
program instructions, stored on at least one of the one or more computer-readable storage media, to record command line inputs associated with the selected options for the current installation of the software application at the computing device;
program instructions, stored on at least one of the one or more computer-readable storage media, to record screen images of the computing device associated with the current installation of the software application; and
program instructions, stored on at least one of the one or more computer-readable storage media, to generate a replayable input sequence based on the selected options, the command line inputs and the screen images.

17. The computer program product of claim 16, further comprising:
program instructions, stored on at least one of the one or more computer-readable storage media, to determine that the current installation of the software application is completed successfully on the computing device; and
program instructions, stored on at least one of the one or more computer-readable storage media, to transmit a notification of an availability of the successful installation data, wherein the successful installation data includes the selected options, the command line inputs, the screen images and the replayable input sequence.

18. The computer program product of claim 17, further comprising:
program instructions, stored on at least one of the one or more computer-readable storage media, to register the computing device with a group of known devices, wherein the group of known devices includes the known computing device;
program instructions, stored on at least one of the one or more computer-readable storage media, to associate the group of known devices with a successful installation database; and
program instructions, stored on at least one of the one or more computer-readable storage media, to store the successful installation data in the successful installation database.

19. The computer program product of claim 16, wherein the reproducing the equivalent installation on the computing device comprises performing actions of the replayable input sequence automatically on the computing device.

20. The computer program product of claim 16, wherein the reproducing the equivalent installation on the computing device comprises a user of the computing device manually performing one or more actions on the computing device, wherein the actions are selected from a group consisting of: entering the selected options on the computing device, entering the command line inputs on the computing device, and reproducing the screen images.
